(19) United States
(12) Patent Application Publication
(10) Pub. No.: US 2017/0278111 A1
(43) Pub. Date: Sep. 28, 2017

(54) REGISTRY-DEMAND FORECAST METHOD AND APPARATUS

(71) Applicant: MasterCard International Incorporated, Purchase, NY (US)

(72) Inventors: Jean-Pierre GERARD, Croton-On-Hudson, NY (US); Po HU, Norwalk, CT (US)

(21) Appl. No.: 15/083,109

(22) Filed: Mar. 28, 2016

(51) Int. Cl. G06Q 30/02

(52) U.S. Cl. CPC G06Q 30/0201; G06Q 30/0204

(57) ABSTRACT

A system, method, and computer-readable storage medium configured to forecast and model demand.

### BACKGROUND

Field of the Disclosure

Aspects of the disclosure relate in general to computer science. Aspects include an apparatus, system, method and computer-readable storage medium to forecast and model demand.

Description of the Related Art

In the technical fields of computer analytics and operations research, pattern detection includes a number of methods for extracting meaning from large and complex data sets through a combination of operations research methods, graph theory, data analysis, clustering, and advanced mathematics.

Unlike machine learning, deep learning, or data mining, pattern detection is data agnostic, requiring only an ingestible data format to compute correlations in data.

Graph algorithms detect patterns of co-occurrence to create a holistic representation of connections a given set of data. Analysis has been applied to industries including transportation, manufacturing, and other fields, such as computer science.

Another different area of technology is computer modeling or computer simulation.

A computer simulation is a simulation, run on a single computer, or a network of computers, to reproduce behavior of a system. The simulation uses an abstract model (a computer model, or a computational model) to simulate the system. Computer simulations have become a useful part of mathematical modeling of many natural systems in physics (computational physics), astrophysics, climatology, chemistry and biology, human systems in economics, psychology, social science, and engineering. Simulation of a system is represented as the running of the system's model. It can be used to explore and gain new insights into new technology and to estimate the performance of systems too complex for analytical solutions.

Computer simulations vary from computer programs that run a few minutes to network-based groups of computers running for hours to ongoing simulations that run for days. The scale of events being simulated by computer simulations has far exceeded anything possible (or perhaps even imaginable) using traditional paper-and-pencil mathematical modeling. Over 10 years ago, a desert-battle simulation of one force invading another involved the modeling of 66,239 tanks, trucks and other vehicles on simulated terrain around Kuwait, using multiple supercomputers in the Department of Defense High Performance Computer Modernization Program. Other computer modeling examples include: a billion-atom model of material deformation, a 2.64-million-atom model of the complex maker of protein in all organisms called a “ribosome,” a complete simulation of the life cycle of mycoplasma genitalium, and the “Blue Brain” project at the École Polytechnique Fédérale de Lausanne (EPFL) in Switzerland to create the first computer simulation of the entire human brain, right down to the molecular level.

### SUMMARY

Embodiments include a system, apparatus, device, method and computer-readable medium configured to forecast and model demand.

A forecast demand assessment apparatus embodiment comprises a network interface, a processor, and a non-transitory computer-readable storage medium. The network interface receives transaction data regarding a transaction associated with an accountholder. The transaction data further comprises: an account identifier associated with the accountholder, a date and time of transaction, amount of transaction, and a merchant identifier. The network interface receives source registries from a merchant. The source registries identify accountholder future purchases identified by Stocking Keeping Unit, and volume of the accountholder future purchases. The processor matches the transaction data with a Stock Keeping Unit (SKU) level database with a list of purchases made in the transaction. The matching uses the date and time of transaction, the amount of transaction, and the merchant identifier. The list of purchases identifies each item purchase by SKU. The processor generates a variable layer from the list of purchases, the accountholder future purchases, and feedback from a forecast demand prediction model. The processor models behavior of a plurality of accountholders with the variable layer to refine the forecast demand prediction model. The processor generates a specific forecast demand assessment. The non-transitory computer-readable storage medium stores the refined forecast demand prediction model and the specific forecast demand assessment.

### BRIEF DESCRIPTION OF THE DRAWINGS

FIG. 1 is a block diagram illustrating a system forecast and model demand.

FIG. 2 depicts a data flow diagram of a process to detect, forecast and model demand.

FIG. 3 illustrates an embodiment of a system configured to forecast and model demand.

### DETAILED DESCRIPTION

One aspect of the disclosure includes the realization that consumer purchase behavior is a powerful source of information that complements demographics and self-reported preferences to create a complete profile of retail demand behavior.

In another aspect of the disclosure, the use of payment cards, such as credit or debit cards, is ubiquitous in commerce. Typically, a payment card is electronically linked with a payment network to an account or accounts belonging to an accountholder. These accounts are generally deposit accounts, loan or credit accounts at an issuer financial institution. During a purchase transaction, the accountholder can present the payment card in lieu of cash or other forms of payment. For the purposes of this disclosure, a payment card includes, but is not limited to: credit cards, debit cards, prepaid cards, electronic checking, electronic wallet, or mobile device payments.

Payment networks process billions of purchase transactions by accountholders. The data from the purchase transactions can be used to analyze accountholder behavior. Typically, the transaction level data can be used only after it is summarized up to customer level. Unfortunately, the current transaction rolled-up processes are pre-knowledge based and does not result in transaction level models.

Another aspect of the disclosure includes the understanding that in addition to analyzing accountholder spending, accountholder potential future purchases provides a source of predictive information that may be used to assess demand behavior. Accountholder potential future purchases are reflected in a registry, also sometimes referred to as a “gift registry,” “wish lists” and pre-orders. These accountholder potential future purchases may also be referred to as “source registries.”

Embodiments of the present disclosure include a system, method, and computer-readable storage medium configured to detect, forecast and model retail demand.

Embodiments solve a technical problem of being able to efficiently identify and model retail demand by utilizing and analyzing consumer transaction data and potential future purchases reflected by source registries.

The systems and processes are not limited to the specific embodiments described herein. In addition, components of each system and each process can be practiced independently and separately from other components and processes described herein. Each component and process also can be used in combination with other systems and processes.

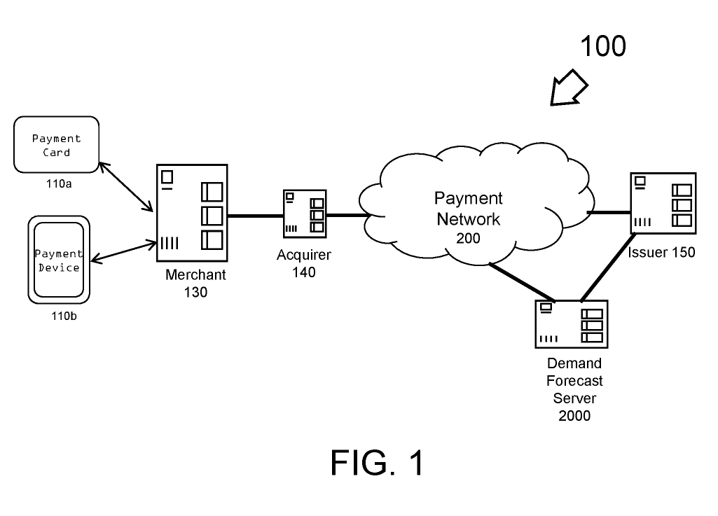

FIG. 1 is a block diagram 100 illustrating a system to identify and model retail demand by utilizing and analyzing consumer transaction data and potential future purchases reflected by source registries. The present disclosure is related to a payment network system, such as a payment card system using a payment network 200, such as the MasterCard® interchange,

Cirrus® network, or Maestro®. The MasterCard interchange is a proprietary communications standard promulgated by MasterCard International Incorporated of Purchase, New York, for the exchange of financial transaction data between financial institutions that are customers of MasterCard International Incorporated. Cirrus is a worldwide interbank network operated by MasterCard International Incorporated linking debit and payment devices to a network of ATMs throughout the world. Maestro is a multi-national debit card service owned by MasterCard International Incorporated.

In a financial payment system 100, a financial institution called the “issuer” 150 issues a payment account to a consumer, who uses payment device 110a-b to tender payment for a purchase from merchant 130. Payment devices may include a payment card 110a, or a mobile device 110b (such as key fobs, mobile phones, tablet computers, Personal Digital Assistants (PDAs), electronic wallets and the like). Payment devices may be used to tender purchase in-person at merchant 130 or conduct electronic payments over the Internet (not shown).

Gift registries, “wish lists” and pre-orders on products and services may be retrieved by demand forecast server 2000 from merchant 130. In some embodiments, merchant 130 transmits the information directly to demand forecast server 2000; in other embodiments, demand forecast server 2000 retrieves the information from merchant 130 using a web crawler.

Actual purchase behavior by accountholders may be determined using the financial payment system 100.

In this example, using a payment card 110a or payment device 110b, a consumer makes a purchase or pre-order at merchant 130. Alternatively, the consumer may add a product or service on a merchant 130 gift registry or “wish list.”

During the purchase or pre-order transaction, the consumer presents the payment device 110 to a point-of-sale device at the merchant 130. The merchant 130 is affiliated with a financial institution. This financial institution is usually called the “merchant bank,” “acquiring bank” “acquirer bank,” or acquirer 140. When a payment device 110 is tendered at merchant 130, the merchant 130 electronically requests authorization from the acquirer 140 for the amount of the purchase. The authorization request is performed electronically with the consumer's account information and transaction information that describes the details of the transaction.

For payment cards, the consumer's account information may be retrieved from the magnetic stripe on a payment card 110a or via a computer chip imbedded within the card 110a. For other types of payment devices 110b, the consumer's account information may be retrieved by wireless methods, such as contactless communication like MasterPass® or via Near Field Communication (NFC). In some embodiments, account information may be a Primary Account Number (PAN).

The transaction information is governed by International Standards Organization (ISO) standard 8583 (“ISO 8583 Financial transaction card originated messages—Interchange message specifications”). The transaction information includes encoded details of the transaction, including: transaction amount, the terminal (merchant identifier), currency type, date, and time.

The account information, along with the transaction information, is forwarded to transaction processing computers of the acquirer 140. Alternatively, an acquirer 140 may authorize a third party to perform transaction processing on its behalf. In this case, the merchant 130 will be configured to communicate with the third party. Such a third party is usually called a “merchant processor” or an “acquiring processor” (not shown).

The computers of the acquirer 140 or the merchant processor will communicate, via payment network 200, with the computers of the issuer 150 to determine whether the consumer's account is in good standing and whether the accountholder should be approved for the purchase. It is understood that any number of issuers 150 may be connected to payment network 200.

Assuming the issuer 150 approves the transaction, the payment network 200 forwards the approval to the merchant 130 via acquirer 140.

A record of transactions is retrieved from payment network 200 and stored at demand forecast server 2000.

In some embodiments, demand forecast server 2000 may exist at payment network 200 or issuer 150.

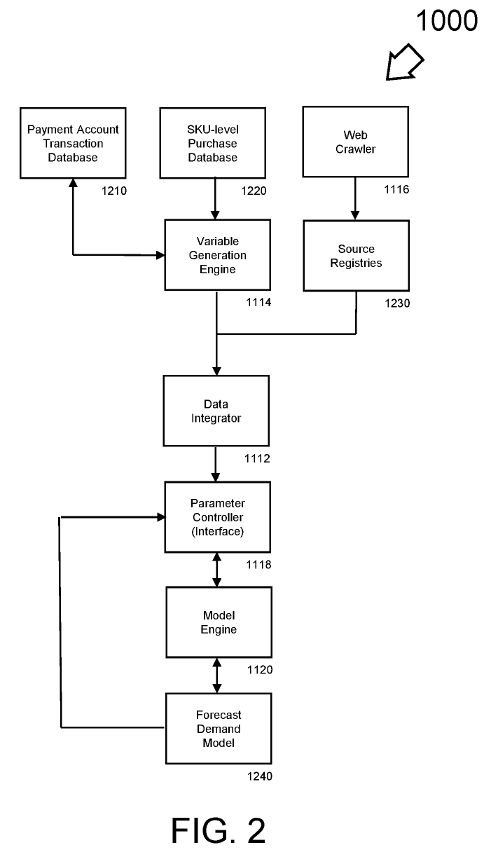

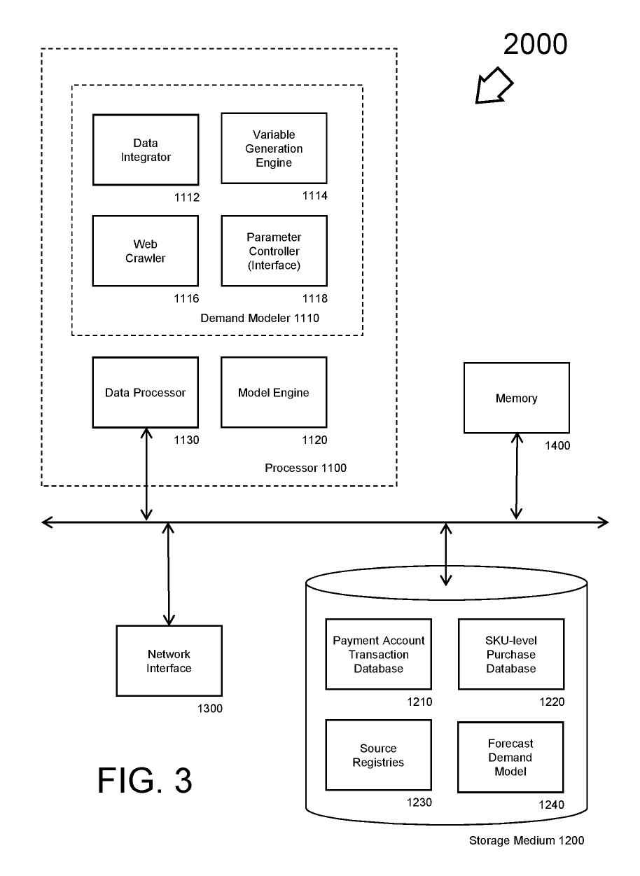

Embodiments will now be disclosed concurrently with reference to a block diagram of a data flow diagram of a retail demand forecast and modeling method 1000 of FIG. 2, being executed by an exemplary demand forecast server 2000 of FIG. 3, constructed and operative in accordance with an embodiment of the present disclosure.

With reference to FIG. 3, demand forecast server 2000 may run a multi-tasking operating system (OS) and include at least one processor or central processing unit (CPU) 1100, a non-transitory computer-readable storage medium 1200, and a network interface 1300. An example operating system may include Advanced Interactive Executive (AIX™) operating system, UNIX operating system, or LINUX operating system, and the like.

Processor 1100 may be a central processing unit (CPU), microprocessor, micro-controller, computational device or circuit known in the art. In some embodiments, apparatus 2000 may have one or more processors 1100. It is understood that processor 1100 may communicate with and temporarily store information in memory 1400, which is a Random Access Memory (RAM).

As shown in FIG. 3, processor 1100 is functionally comprised of a demand modeler 1110, a model engine 1120, and a data processor 1130.

Demand modeler 1110 is a component configured to forecast and model retail demand by analyzing accountholder transactions and source registries 1230 in the storage medium 1200. Demand modeler 1110 may further comprise: a data integrator 1112, variable generation engine 1114, web crawler 1116, and a parameter controller (interface) 1118.

Data integrator 1112 is an application program interface (API) or any structure that enables the demand modeler 1110 to communicate with, or extract data from, a database.

Variable generation engine 1114 is any structure or component capable of generating customer level target-specific variable layers from given transaction level data.

Web crawler 1116 is any structure configured to systematically browse the World Wide Web (WWW), typically for the purpose of web indexing. A web crawler 1116 may also be called a web spider, an ant, an automatic indexer, or a web scutter. In some embodiments, demand modeler 1110 may use web crawler 1116 to extract gift registries or “wish lists” from merchant-related websites, to determine accountholder potential future purchases, and store them in source registries 1230. The accountholder potential future purchases may be identified by the product or service's SKU; additionally, the web crawler 1116 may also identify an intended volume (number of units) of each accountholder potential future purchase. For example, web crawler 1116 may determine that an accountholder intends to buy four shirts, and the shirts are identified by a specific SKU. It is understood by one skilled in the art that web crawler 1116 uses a network interface 1300 in the extraction from the merchant-related websites.

Parameter controller 1118 is an interface structure that allows users of the demand modeler 1110 to enter, test, and adjust different parameters and control machine learning speed of model engine 1120.

Model engine 1120 is an application that utilizes forecast demand information produced by demand modeler 1110 to create a forecast demand model 1240. In some embodiments, a feedback mechanism allows model engine 1120 to receive input from forecast demand model 1240 and demand modeler 1110 to refine the forecast demand model 1240.

In some embodiments, model engine 1120 uses an autoregressive moving average model, decision tree learning, association rule learning, neural networks, inductive logic programming, support vector machines, clustering, Bayesian networks, reinforcement learning, representation learning, similarity and metric learning, spare dictionary learning, and ensemble methods such as random forest, boosting, bagging, and rule ensembles, or a combination thereof.

Data processor 1130 enables processor 1100 to interface with storage medium 1200, network interface 1300, memory 1400 or any other component not on the processor 1100. The data processor 1130 enables processor 1100 to locate data on, read data from, and write data to these components.

The structures described as part of processor 1100 may be implemented as hardware, firmware, or software encoded on a computer readable medium, such as storage medium 1200. Further details of these components are described with their relation to method embodiments below.

Network interface 1300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 1300 allows demand forecast server 2000 to communicate with merchants 130, accountholders, issuers 150 and acquirers 140.

Computer-readable storage medium 1200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage medium 1200 may be remotely located from processor 1100, and be connected to processor 1100 with a network, such as a local area network (LAN), a wide area network (WAN), or the Internet.

In addition, as shown in FIG. 3, storage medium 1200 may also contain a payment account transaction database 1210, SKU-level purchase database 1220, source registries 1230 and a forecast demand model 1240.

Payment account transaction database 1210 is configured to store records of payment card transactions. SKU-level purchase database 1220 is configured to store SKU-level purchase information from merchant transactions; in some embodiments, the SKU-level purchase database 1220 may contain a plurality of transactions with SKU-level information about every item purchased in each purchase transaction. Source registries 1230 are accountholder potential future purchases extracted from gift registries, pre-orders “wish lists” and the like. In some embodiments, the source registries 1230 are reported from merchant-related websites or extracted from merchant-related websites by a web crawler 1116. A forecast demand model 1240 is a retail forecast demand model based on aggregate accountholder transactions and source registries. In some embodiments, an initial forecast demand model based on estimated demand may be used initially for as the forecast demand model 1240, to be refined by the aggregate accountholder purchase transactions and source registries.

It is understood by those familiar with the art that one or more of these databases 1210-1240 may be combined in a myriad of combinations. The function of these structures may best be understood with respect to the data flow diagram of FIG. 2, as described below.

We now turn our attention to the method or process embodiments of the present disclosure described in the data flow diagram of FIG. 2. It is understood by those known in the art that instructions for such method embodiments may be stored on their respective computer-readable memory and executed by their respective processors.

FIG. 2 is a data flow diagram of a forecast demand modeling method 1000 to retail demand forecast and prediction modeling based on aggregate accountholder payment card purchases and source registries, constructed and operative in accordance with an embodiment of the present disclosure. The resulting forecast demand model 1240 may be used forecasting demand of specific items and, as a result, allow merchants 130 to better control their inventory.

As shown in FIG. 2, data integrator 1112 receives input from payment account transaction database 1210, SKU-level purchase database 1220 and source registries 1230. For each individual accountholder analyzed, the model engine 1120 receives the individual accountholder's transaction data from the payment account transaction database 1210. For each transaction, the transaction data includes an account identifier, a time and date of the transaction, the merchant location or venue for the transaction (merchant identifier), and the amount of the transaction. In some embodiments, the account identifier may be a Primary Account Number (PAN). Each transaction may then be cross-referenced with transactions found in merchant provided information provided by SKU-level purchase database 1220. The cross-referencing may be accomplished using the merchant identifier (indicating merchant location or venue for the transaction), the time and date of the transaction, and the amount of the transaction. The cross-referencing allows model engine 1120 to determine the individual items (identified by the SKU) purchased with each transaction. This transaction information is provided to the variable generation engine 1114, which produces a variable layer with transaction attribute variables to support the forecast demand analysis.

Variable generation engine 1114 produces a variable layer with transaction attribute variables to support the forecast demand analysis. The variable generation engine 1114 may use independent variables to form a base line to define the forecast demand behavior. Independent variables may include, but are not limited to: purchase frequency, ticket size, industry category, geo-location from the data. The following example illustrates how the variable generation engine 1114 works on merchant-level data. The same approach can be used for product-level (SKU level) data.

TABLE 1
Sample Merchant-Level Data

| Account | Trans | | | | | | | |
|---|---|---|---|---|---|---|---|---|
| ID | ID | Tran-Date | Trans_Time | | Merchant ID | Channel | Trans-Type | Amount |
| 1 | 1 | 12/1/2013 | 6:08:10 | PM | 1 | B | Payment | $68.64 |
| 1 | 2 | 12/8/2013 | 6:49:52 | PM | 1 | B | Payment | $52.25 |
| 1 | 3 | 12/15/2013 | 5:50:29 | PM | 1 | B | Payment | $63.46 |
| 1 | 4 | 12/22/2013 | 7:29:28 | PM | 1 | B | Payment | $52.43 |
| 1 | 5 | 12/29/2013 | 5:52:58 | PM | 1 | B | Payment | $55.74 |
| 1 | 6 | 1/5/2014 | 7:00:59 | PM | 1 | B | Payment | $55.44 |
| 1 | 7 | 1/12/2014 | 6:26:36 | PM | 1 | B | Payment | $61.18 |
| 2 | 1 | 12/1/2013 | 7:18:22 | PM | 8 | B | Payment | $65.62 |
| 2 | 2 | 12/8/2013 | 8:22:00 | AM | 6 | B | Payment | $104.30 |
| 2 | 3 | 12/17/2013 | 10:59:40 | AM | 6 | B | Payment | $139.90 |
| 2 | 4 | 12/23/2013 | 11:25:12 | AM | 7 | B | Payment | $170.63 |
| 2 | 5 | 12/26/2013 | 1:46:28 | AM | 8 | B | Payment | $29.71 |
| 2 | 6 | 1/3/2014 | 12:43:20 | PM | 7 | B | Payment | $75.17 |
| 2 | 6 | 1/8/2014 | 6:09:49 | PM | 9 | B | Payment | $78.65 |
| 2 | 6 | 1/20/2014 | 4:53:04 | PM | 10 | B | Payment | $146.38 |
| 2 | 6 | 1/26/2014 | 7:36:32 | PM | 3 | B | Payment | $66.02 |
| 2 | 6 | 2/5/2014 | 2:32:12 | AM | 2 | O | Payment | $159.32 |
| 2 | 6 | 2/18/2014 | 10:43:30 | AM | 8 | B | Payment | $102.12 |
| 2 | 6 | 2/25/2014 | 4:32:39 | PM | 8 | B | Payment | $42.04 |
| 2 | 6 | 3/9/2014 | 4:40:48 | AM | 3 | B | Payment | $36.16 |
| 2 | 6 | 3/23/2014 | 9:49:41 | AM | 4 | B | Payment | $124.55 |

The variable generation engine 1114 summarizes transactions and creates aggregate accountholder-level variables. It can summarize many variables based on time duration, frequency, channel, amount by each merchant or merchant groups, or any other independent variable. As shown in Table 1 above, customer 1 (with ID=1) only used their payment card account at one merchant on Sundays and around 5 PM to 7 PM. The purchase amount is also similar in the range of $50 to $70. The consumer pattern is very clear. Customer 2, with ID=2, shopped in a more random pattern across multiple merchants, different dates and times, and different channels. The amount spent is also very different. For example, suppose a snapshot is taken at the end of 2013. Transaction frequency over last month can be determined at each merchant. For customer 1, the number of transactions at merchant 1 (shown by Merchant Location=1) is five, and for all other merchants is zero. For customer 2, the number of transactions for merchants 1 or 5 is zero, but the number transactions for other merchants is greater than zero. There are many options to summarize different variables based transaction frequency, amount, channel, and time interval by merchant or merchant group. The variable generation engine 1114 maximally uses the transaction information and generates as many variables as possible that are useful and related to future behavior patterns. Statistical techniques are used to derive forecast demand insights, based on the independent transaction attribute variables. The attribute variables are used as potential predictors. Predictive modeling techniques are used to identify patterns in the attribute variables to find similar predictive instances in the present.

In parallel, web crawler 1116 scrapes merchant-related web sites for accountholder potential future purchases from gift registries, pre-orders or “wish lists.” The accountholder potential future purchases may be determined at an aggregate number of units of a particular product (based on product SKU).

Data integrator 1112 receives the independent transaction attribute variables from the variable generation engine 1114, and stores the detected impulse purchase data in the payment account transaction database 1210, integrating the data in the accountholder's record. Data integrator 1112 provides the data to the parameter controller (interface) 1118, which (as described below) controls the machine learning rate of model engine 1120.

Model engine 1120 utilizes the independent transaction attribute variables (representing forecast demand information) produced by demand modeler 1110 (shown in its various components in FIG. 2) to create a forecast demand model 1240. In some embodiments, a feedback mechanism allows model engine 1120 to receive input from forecast demand model 1240 and demand modeler 1110 to refine the forecast demand model 1240.

Model engine 1120 may calculate an autoregressive moving average including exogenous covariates model (referred to in the art as an “ARIMAX” model). In such an ARIMAX embodiment, the model engine 1120 extends an autoregressive moving average (ARMA) model by including a linear effect that one or more exogenous series has on the stationary response of the autoregressive moving average. An exogenous series is a series that involves an alteration of a variable that is autonomous, i.e., unaffected by the workings of the model. In this embodiment, the exogenous series may be provided by the source registries 1230.

For an ARIMAX model, the notation ARIMAX(p, q, b) refers to a model with p autoregressive terms, q moving average terms and b exogenous input terms. The ARIMAX model contains the AR(p) and MA(q) models and a linear combination of the last b terms of a known and external time series dₜ. This is shown by:

$${X}_{t} = {ɛ}_{t} + {\sum }_{i = 1}^{p} {ϕ}_{i} {X}_{t - i} + {\sum }_{i = 1}^{q} {θ}_{i} {ɛ}_{t - i} + {\sum }_{i = 0}^{b} {η}_{i} {d}_{t - i} .$$

where:

εₜ is white noise,

φ₁, . . . , φₚ are the parameters of the autoregressive portion of the model,

θ₁, . . . , θ_{q} are the parameters of the moving average portion of the model, and

ƒ₂, . . . , ƒ_{b} are the parameters of the exogenous input dₜ.

The parameter controller 1118 controls the parameters of the model engine 1120. Specifically, it allows user control of the forecast horizon of the autoregressive moving average, the order of the autoregressive part (“p”), the order of the moving average part (“q”), and the exogenous factors (dₜ).

Once generated, the transaction attribute of interest is provided to the model engine 1120 and the parameter controller 1118. The parameter controller 1118 receives inputs from both the variable generation engine 1114 and the model engine 1120 to refine the forecast demand model 1240. Parameter controller 1118 starts with dozens of attributes of the transaction data, and computes the implicit relationships of these attributes and the relationship of the attributes to the model engine 1120.

From vast transaction accounts and transaction times, nature of the transaction store, purchase amounts, and list of purchased items, the model engine 1120 can define extreme aggregate groups of accounts to forecast demand. One group has consistent transaction patterns and only shopping in daily product stores like automotive fuel, grocery stores, and the like. The second group, of the forecast demand customers, has inconsistent transaction patterns. Most aggregate groupings of accounts are in between of these two groups. Using a modeling approach to map the two extremes, the model engine 1120 can create a forecast demand model 1240 that projects the future demand at a merchant 130 (identified by the merchant identifier) as a whole, of a product (identified by SKU), or of a service (identified by SKU).

The model engine 1120 may then transmit or display a specific forecast demand assessment for the merchant, product, or service. The specific forecast demand assessment may be a numeric score, a projected number of units, or a dollar amount of the projected demand.

The specific forecast demand assessment may be stored in the payment account transaction database 1210 as part of the accountholder record or as part of the forecast demand model 1240. In some embodiments, the specific forecast demand assessment is transmitted as part of a message to a merchant, issuer financial institution, or acquirer financial institution.

It should be noted that the systems, methods and apparatus described herein are intended to be employed in accordance with applicable data privacy laws and regulations, including accountholder notice and consent where required.

The previous description of the embodiments is provided to enable any person skilled in the art to practice the disclosure. The various modifications to these embodiments will be readily apparent to those skilled in the art, and the generic principles defined herein may be applied to other embodiments. Thus, the present disclosure is not intended to be limited to the embodiments shown herein, but is to be accorded the widest scope consistent with the principles and novel features disclosed herein.

What is claimed is:

1. A forecast demand assessment and modeling method comprising:
receiving, with a network interface, transaction data regarding a transaction associated with an accountholder, the transaction data further comprising: an account identifier associated with the accountholder, a date and time of transaction, amount of transaction, and a merchant identifier;
matching, with a processor, the transaction data with a Stock Keeping Unit (SKU) level database with a list of purchases made in the transaction, the matching using the date and time of transaction, the amount of transaction, and the merchant identifier, the list of purchases identifying each item purchase by Stock Keeping Unit;
receiving source registries from a merchant with the network interface, the source registries identifying accountholder future purchases identified by Stocking Keeping Unit, and volume of the accountholder future purchases;
generating, with the processor, a variable layer from the list of purchases, the accountholder future purchases, and feedback from a forecast demand prediction model;
modeling, with the processor, behavior of a plurality of accountholders with the variable layer to refine the forecast demand prediction model and to generate a specific forecast demand assessment;
storing the refined forecast demand prediction model and the specific forecast demand assessment to a non-transitory computer-readable storage medium.

2. The forecast demand assessment method of claim 1,
wherein the modeling with the processor uses an autoregressive moving average including exogenous covariates (ARIMAX) model.

3. The forecast demand assessment method of claim 2,
wherein the source registries provide an exogenous series for the ARIMAX model.

4. The forecast demand assessment method of claim 3, wherein the receiving of the source registries from a merchant is accomplished with a web crawler.

5. The forecast demand assessment method of claim 4, wherein the specific forecast demand assessment projects future demand at a merchant specified by the merchant identifier.

6. The forecast demand assessment method of claim 5, wherein the specific forecast demand assessment projects future demand is a dollar amount of the projected demand.

7. The forecast demand assessment method of claim 4, wherein the specific forecast demand assessment projects future demand of a product or service specified by Stock Keeping Unit.

8. A forecast demand assessment apparatus comprising:
a network interface configured to receive transaction data regarding a transaction associated with an accountholder, the transaction data further comprising: an account identifier associated with the accountholder, a date and time of transaction, amount of transaction, and a merchant identifier, and to receive source registries from a merchant with the network interface, the source registries identifying accountholder future purchases identified by Stocking Keeping Unit, and volume of the accountholder future purchases;
a processor configured to match the transaction data with a Stock Keeping Unit (SKU) level database with a list of purchases made in the transaction, the matching using the date and time of transaction, the amount of transaction, and the merchant identifier, the list of purchases identifying each item purchase by Stock Keeping Unit, to generate a variable layer from the list of purchases, the accountholder future purchases, and feedback from a forecast demand prediction model, and to model behavior of a plurality of accountholders with the variable layer to refine the forecast demand prediction model and to generate a specific forecast demand assessment;
a non-transitory computer-readable storage medium configured to store the refined forecast demand prediction model and the specific forecast demand assessment to a non-transitory computer-readable storage medium.

9. The forecast demand assessment apparatus of claim 8,
wherein the modeling with the processor uses an autoregressive moving average including exogenous covariates (ARIMAX) model.

10. The forecast demand assessment apparatus of claim 9,
wherein the source registries provide an exogenous series for the ARIMAX model.

11. The forecast demand assessment apparatus of claim 10, wherein the receiving of the source registries from a merchant is accomplished with a web crawler.

12. The forecast demand assessment apparatus of claim 11, wherein the specific forecast demand assessment projects future demand at a merchant specified by the merchant identifier.

13. The forecast demand assessment apparatus of claim 12, wherein the specific forecast demand assessment projects future demand is a dollar amount of the projected demand.

14. The forecast demand assessment apparatus of claim 11, wherein the specific forecast demand assessment projects future demand of a product or service specified by Stock Keeping Unit.

15. A forecast demand assessment apparatus comprising:
means for receiving transaction data regarding a transaction associated with an accountholder, the transaction data further comprising: an account identifier associated with the accountholder, a date and time of transaction, amount of transaction, and a merchant identifier;
means for matching the transaction data with a Stock Keeping Unit (SKU) level database with a list of purchases made in the transaction, the matching using the date and time of transaction, the amount of transaction, and the merchant identifier, the list of purchases identifying each item purchase by Stock Keeping Unit;
means for receiving source registries from a merchant, the source registries identifying accountholder future purchases identified by Stocking Keeping Unit, and volume of the accountholder future purchases;
means for generating a variable layer from the list of purchases, the accountholder future purchases, and feedback from a forecast demand prediction model;
means for modeling behavior of a plurality of accountholders with the variable layer to refine the forecast demand prediction model and to generate a specific forecast demand assessment;
means for storing the refined forecast demand prediction model and the specific forecast demand assessment.

16. The forecast demand assessment apparatus of claim 15,
wherein the modeling with the processor uses an autoregressive moving average including exogenous covariates (ARIMAX) model.

17. The forecast demand assessment apparatus of claim 16,
wherein the source registries provide an exogenous series for the ARIMAX model.

18. The forecast demand assessment apparatus of claim 17, wherein the receiving of the source registries from a merchant is accomplished with a web crawler.

19. The forecast demand assessment apparatus of claim 18, wherein the specific forecast demand assessment projects future demand at a merchant specified by the merchant identifier.

20. The forecast demand assessment apparatus of claim 19, wherein the specific forecast demand assessment projects future demand is a dollar amount of the projected demand.
